(19) United States
(12) Patent Application Publication
(10) Pub. No.: US 2026/0118088 A1
(43) Pub. Date: Apr. 30, 2026

(54) PEEP SIGHT WITH ACHROMATIC LENS

(71) Applicant: X-Focus 365, LLC, Milford, IA (US)

(72) Inventors: Rocky Thompson, Milford, IA (US); Allan Schuster, Spencer, IA (US)

(21) Appl. No.: 18/931,379

(22) Filed: Oct. 30, 2024

(51) Int. Cl. F41B 5/14; G02B 13/00; G02B 27/00

(52) U.S. Cl. CPC F41B 5/1419; G02B 13/006; G02B 27/0056

(57) ABSTRACT

An achromatic lenses for a peep sight is to be mounted onto an archery bowstring. The achromatic lens is to be situated and retained in a lens cavity of the peep sight and includes various positive verifier or a negative clarifier glass lens joined by cement to a negative or positive flint lens, respectively. The peep sight has a peep sight body mounted to the bowstring with an internal hole therethrough with a front end, facing a front bow sight, and a rear end facing an archer's eye. An aperture with the lens cavity has a front end and a rear end and is adapted for locking engagement within the hole of the body. The aperture has a passage therethrough axially aligned with the threaded hole with a front end facing the front bow sight and a rear end to be facing the archer's eye. The lens cavity is in the passage suitably adjacent to the aperture's front end.

### BACKGROUND OF THE INVENTION

The present invention relates to an archery bow peep sight, and more particularly to a peep sight that releasably holds an achromatic lens for an archer. An achromatic lens, also referred to as an achromat, typically consists of two optical components cemented together, usually a positive low-index (glass crown) element and a negative high-index (flint) element. Achromatic lenses or achromats are designed to limit the effects of chromatic and spherical aberrations in visible wavelengths and corrects for red and blue. Achromats make corrections to bring two different visible wavelengths of light (red or blue) into focus within the same image plane.

The rear sight in prior art FIG. 1 is commonly called a peep sight 10 and is installed in the bowstring 12 itself. The front sight 13 for bows commonly has one or more pins mounted to the riser portion 14 just above the hand grip 16. The peep sight has a fixed-sized sighting hole 20 axially through it. Different field conditions such as the amount of present ambient light require different-size holes. This is problematic in that using different peep sights with different-size holes also requires recalibrating each time the peep sight is changed, which is tedious and time consuming.

As shown in prior art FIGS. 2-5, eventually peep sights 24 were provided with interchangeable inserts 26, 28, each with a different size viewing hole 30, 32 depending on ambient light conditions or field conditions. The inserts screw into the peep sight and have smaller and larger holes 30, 32 dependent on users' eyesight and field conditions. The different hole size inserts all have the same axis A of the sighting hole 30, 32 through the peep sight 24 and with the axis A of sight straight to the front sight 13 (FIGS. 9 and 10).

Referring to prior art FIGS. 6-10, one of the early peep sight 36 systems that addressed the viewing problems with far-sighted archers is illustrated in FIG. 9 (out-of-focus fuzzy pins). Far-sightedness- or hyperopia-verifier (positive) lens 40 (FIG. 6) is mounted in the peep sight 36. The verifier lens 40 has a power to permit a far-sighted archer to focus on the front sight 13 alignment pins while keeping the target in focus. This effect is illustrated in prior art FIG. 9 (without a verifier lens) and FIG. 10 (with a verifier lens).

Preferably, the verifier lenses 40 for the peep sight further comprise a plurality of interchangeable and insertable lenses of different powers. In the preferred embodiments, the lenses 40 are of powers generally ranging from 0.5 to 2. diopters with varying peep site viewing holes 30, 32.

In the preferred embodiment, the peep sight body 36 is internally threaded. An adapter 38 is externally threaded to mate with the peep sight body 36 to engage and hold the lens 40 in a pocket 50 in place within the peep sight body 36. Extreme care has to be practiced when changing lenses 40 in the field as the lens 48 are easily dropped and lost.

Prior art FIGS. 7 and 8 illustrate a more modern peep sight 44 with additional features wherein the aperture 46 holds onto the lens 48 with bendable lens tabs 47. The aperture 46 threads into the peep sight 44 and upon lens seat 50. The aperture 46 maybe threadably removed in the field without tools for lens change, inspection, lens cleaning—all while the peep remains mounted on the bowstring.

Prior art FIG. 9 illustrates what the far-sighted archer sees of the pins 56 through a peep sight without the aid of a verifier lens. These are clarity, fuzziness and crispness problems which relentlessly nag the archer when sighting his or her bow. The front sight 13 with pins 56 are fuzzy, unclear and difficult to clearly see. The use of a verifier lens 40 in a peep sight in FIG. 10 illustrates the crispness and clarity of the pins 58 which are what the archer sees through a peep sight verifier glass lens 40.

Peep sight clarifier lenses are available for near-sighted archers which improve poor visibility and give a clearer view of one's target. Clarifiers work to give magnification to the target generally with varying peep sight viewing holes and provide variable powers

Glass lenses do have chromatic and spherical aberration problems. Much like a prism, glass lenses refract and separate white light into red, blue and green. This is not desirable in archery sighting systems. There is a need to solve these chromatic aberration problems. The present invention solves these aberration problem.

### SUMMARY OF THE INVENTION

An achromatic lenses for a peep sight is to be mounted onto an archery bowstring. The achromatic lens is to be situated and retained in a lens cavity of the peep sight and includes various positive verifier or a negative clarifier glass lens joined by cement to a negative or positive flint lens, respectively. The peep sight has a peep sight body mounted to the bowstring with an internal hole therethrough with a front end, facing a front bow sight, and a rear end facing an archer's eye. An aperture with the lens cavity has a front end and a rear end and is adapted for locking engagement within the hole of the body. The aperture has a passage therethrough axially aligned with the peep sight body hole with a front end facing the front bow sight and a rear end to be facing the archer's eye. The lens cavity is in the passage suitably adjacent to the aperture's front end.

A principal object and advantage of the present achromatic lens has never been made small enough to be used in archery peep sights with viewing holes ranging from variously sized small inch fractions in diameter. This invention solves this problem.

Another object and advantage of the present achromatic lens for archery bow peep sights are corrected to bring two different wavelengths of light into focus within the same image plane. A principal object and advantage of the present achromatic lens is its variable small size.

Another object and advantage of the present an achromatic lens, also referred to as an achromat, consists of two optical components cemented together. Usually a positive low-index (crown) element and a negative high-index (flint) element are cemented together in contact with each other. In comparison to a single lens, which only consists of a single piece of glass, the additional design freedom provided by using a two lens design allows for further optimization of performance.

Another object and advantage of the present achromatic lens is that it will have noticeable advantages over a comparable diameter and focal length of a single glass lens. Achromatic lenses or achromats are designed to limit the effects of chromatic and spherical aberrations.

Another object and advantage of the present achromats is that they correct two different wavelengths of light into focus within the same image plane. It is important to note that it can be a two element lens or an achromatic lens designed for visible wavelengths corrections for red and blue light waves.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The figure descriptions are as follows:

FIG. 1 is a prior art rear perspective view of an archer sighting his bow with a front pin sight and a rear peep sight;

FIG. 2 is a prior art front perspective view of a peep sight with a removable peep sight aperture;

FIGS. 3 and 4 are prior art cross sectional views of the removable peep sight apertures of different sized sight viewing boles;

FIG. 5 is a prior art top plane view of a peep sight system including a wrench, interchangeable viewing aperture, a peep sight body and a flexible connector to be attached to the bow cable;

FIG. 6 is a prior art side cross sectional view of a peep sight system with an adapter that is externally threaded to mate internally with the peep sight body to engage and hold a lens in a pocket within the peep sight body;

FIG. 7 is a prior art front elevational view of a modern peep sight having an aperture with a lens cavity that is externally threaded to mate with the peep sight body to engage and hold the lens in a pocket or lens cavity with flexible lens retainers or fingers movable by one or two finger nails;

FIG. 8 is a prior art exploded front elevational view of the peep sight of FIG. 7 showing a lens within the cavity in phantom outline with flexible lens retainers, tabs or fingers holding the lens in place within the cavity;

FIG. 9 is a prior art front elevational view through a peep sight of the front sight with a target animal in view showing the fuzzy, unclear, blurred sight pins which the far sighted archer actually sees;

FIG. 10 is a prior art front elevational view through a peep sight of the front sight with a target animal in view showing clear and crisp sight pins which the far sighted archer actually sees when using a verifier lens in the peep sight;

FIG. 11 is a side elevational view of an achromatic lens with a clarifier negative lens and a positive flint lens;

FIG. 12 is a side elevational view of an achromatic lens with a verifier positive lens;

FIG. 13 is side elevational illustrating chromatic aberrations of a single clarifier glass lens refracting the white light into red, green and blue onto the archer's focal retina plane;

FIG. 14 a side elevational view illustrating chromatic aberrations of a single glass lens mounted on a bow string without peep sight details refracting the white light into red, green and blue onto the archer's focal retina plane;

FIG. 15 illustrates the archer's view through the peep sight and forward bow sight showing a target with chromatic aberrations of a single clarifier/negative glass lens in a peep sight mounted on a bow string;

FIG. 16 illustrates the archer's view through the peep sight and forward bow sight showing a deer or a deer decoy with chromatic aberrations of a single clarifier/negative glass lens in a peep sight mounted on a bow string;

FIG. 17 is side elevational view of a verifier achromatic lens correcting chromatic aberrations;

FIG. 18 is a comparison view of a single verifier/positive glass lens with chromatic aberrations compared to a clarifier/positive achromatic lens showing no chromatic aberrations;

FIG. 19 is a side elevational view illustrating no chromatic aberrations of a positive glass/flint achromatic lens mounted on a bow string without peep sight details showing the red, green and blue aberrations corrected to white light onto the archer's focal retina plane;

FIG. 20 illustrates the archer's view through the peep sight and forward bow sight showing a target with no chromatic aberrations of a achromatic clarifier/negative lens in a peep sight mounted on a bow string; and

FIG. 21 illustrates the archer's view through the peep sight and forward bow sight showing a deer decoy with no chromatic aberrations of an achromatic clarifier negative lens in a peep sight mounted on a bow string.

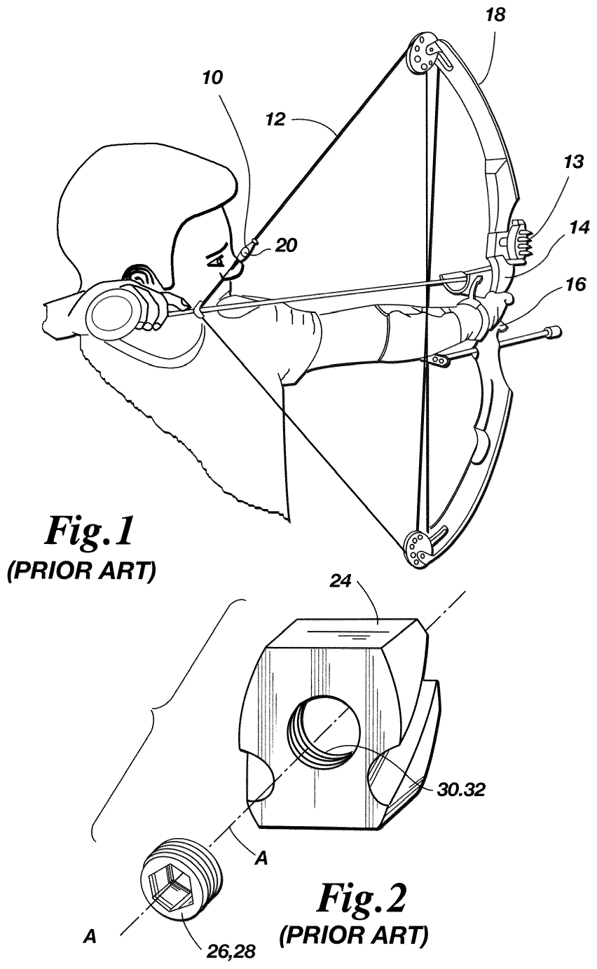

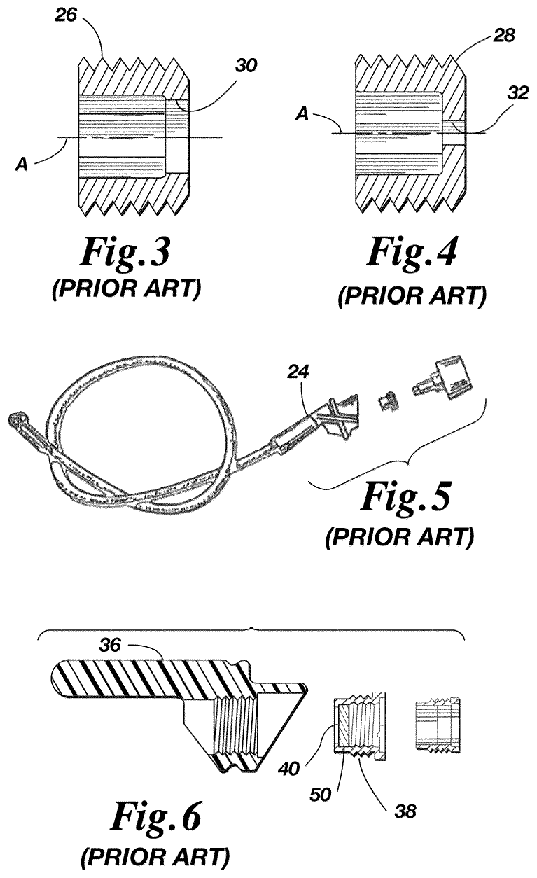

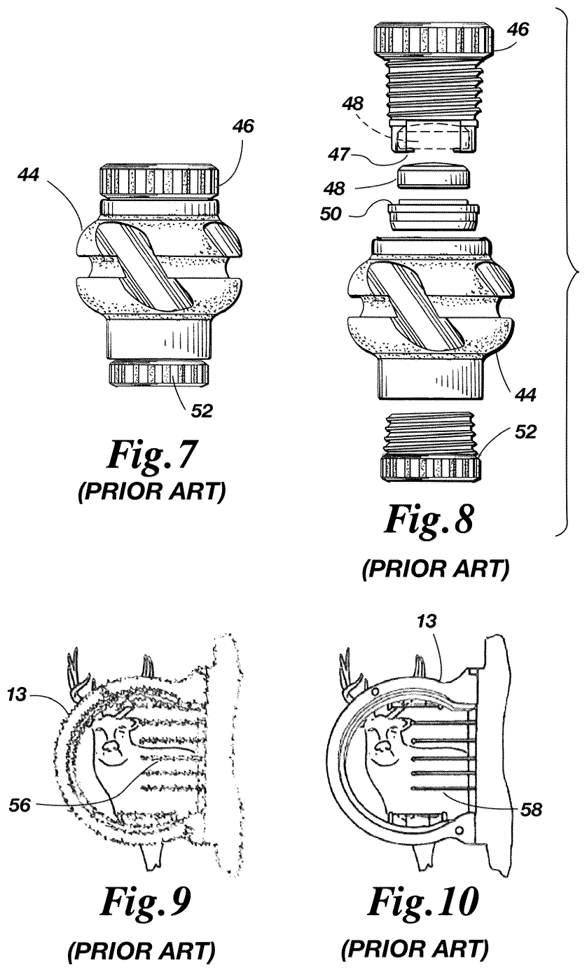

### DETAILED SPECIFICATION

The present invention is an achromatic lens or an achromat used in archery peep sights on an archery bow to correct chromatic and on-axis spherical spherical aberrations.

An achromat is a lens that is designed to limit the effects of chromatic and spherical aberrations. Achromatic lenses are corrected to bring two wavelengths (typically red and blue) into focus in the same plane. The most useful type of achromat in archery is an achromatic double, which is composed of two individual lenses made from glass and flint with different amounts of dispersion. Typically, one element is a negative (concave) element made out of flint glass, which has relatively high dispersion, and the other is a positive (convex) element made of crown glass, which has lower dispersion. The lens elements are mounted next to each other, often cemented together, and shaped so that the chromatic aberration of one is counterbalanced by that of the other.

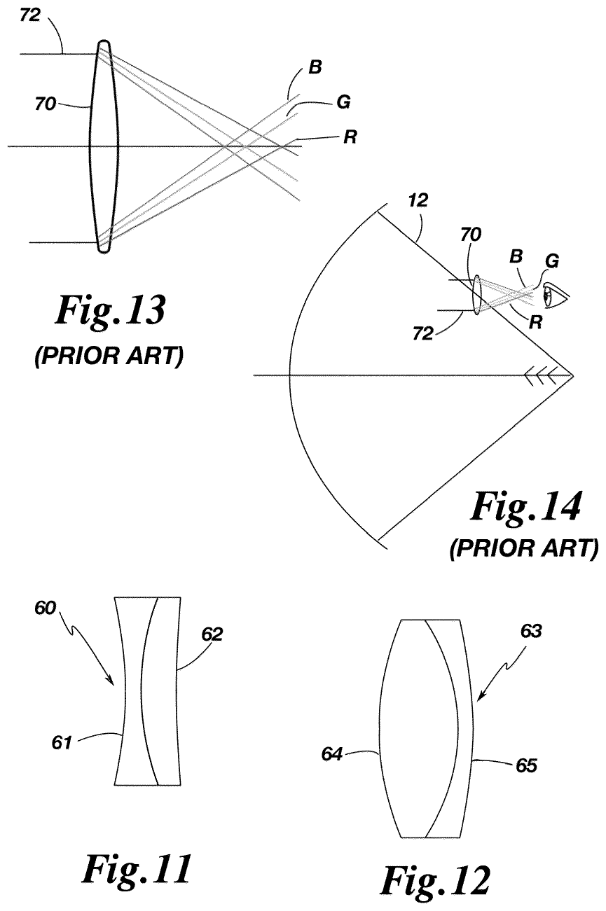

Referring to FIG. 11, negative (clarifier) achromatic lenses 60 consist of two optical components, a negative glass concave lens 61 and a concave flint glass lens 62 cemented together. As is true to all achromats, they are corrected for color and on-axis spherical aberration. Referring to FIG. 12, positive (verifier) achromat lenses 63 consist of two optical elements, usually of positive crown glass lens 64 and a negative flint glass lens 65 and again are cemented together to form an achromatic double lens. The crown can be a single concave lens or a bi-concave lens. The crown lens can be a single or biconvex positive lens and the negative flint lens is concave Due to the difference in refractive indices, chromatic aberration with respect to two selected wavelengths has been corrected. The lenses have also been corrected for on-axis spherical aberration as well.

Referring to FIG. 13, a single positive or verifier lens 70 refracts white light 72 and breaks out individual red R, green G and blue B light waves. FIG. 14 shows this effect in an archery setting wherein the positive single glass lens 70 breaks or refracts the white light 72 into a blurry image with chromatic aberrations of red R, green G and blue B onto the archer's retinal focal plane.

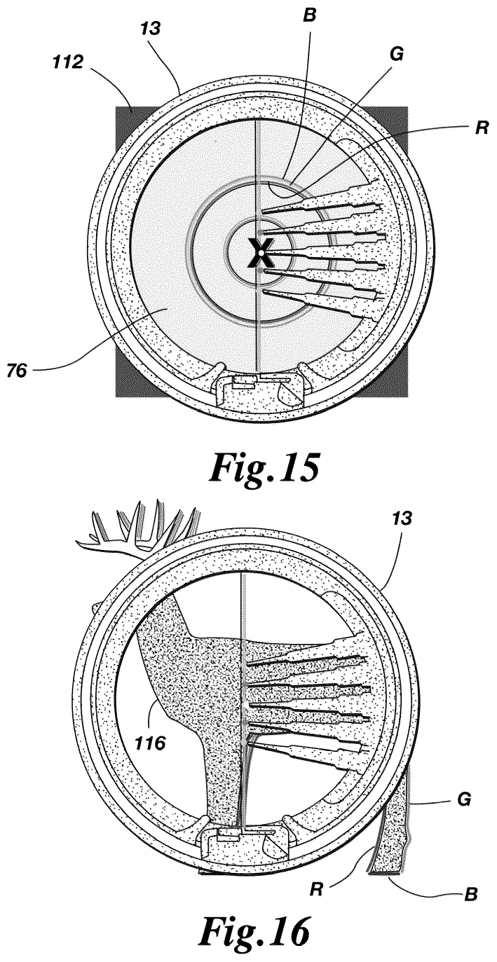

FIG. 15 illustrates the archer's view through the peep sight 36, 44 and forward bow sight 13 showing a target 112 with chromatic aberrations R, G and B of a single clarifier/negative glass lens in a peep sight 36, 44 mounted on a bow string 12. Similarly, FIO. 16 illustrates the archer's view through the peep sight 36, 44 and forward bow sight 13 showing some aberration of a deer or deer decoy 116 with chromatic aberrations of a single clarifier/negative glass lens in a peep sight 36, 44 mounted on a bow string 12.

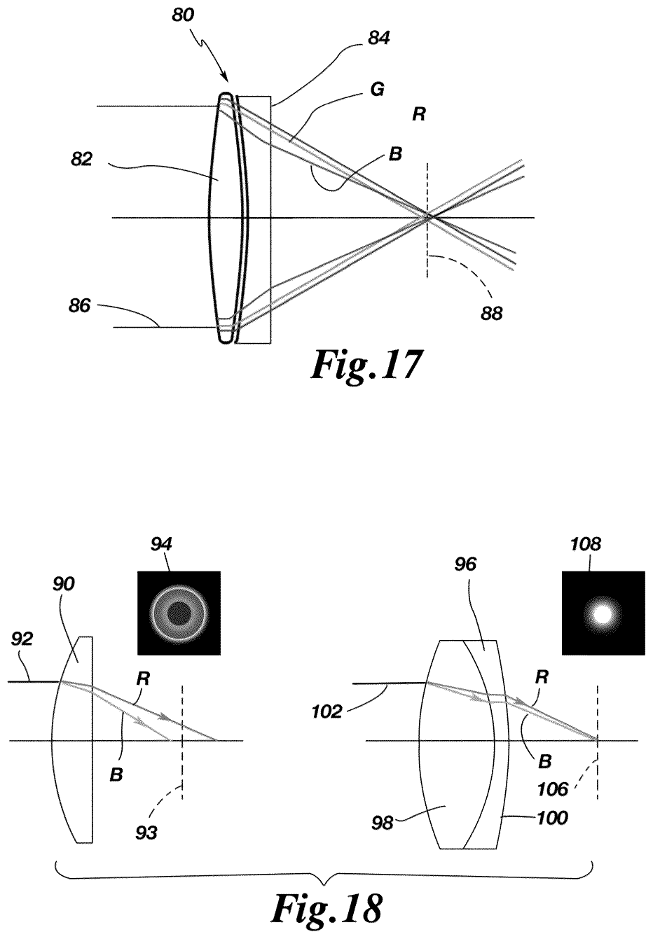

Referring to FIG. 17, shows a double achromatic lens 80 comprised of a positive convex glass crown lens 82 cemented to a negative flint concave lens 84 that corrects the focal plane to white and the aberrations of red R, green G and blue B light waves are corrected to the focal plane 88.

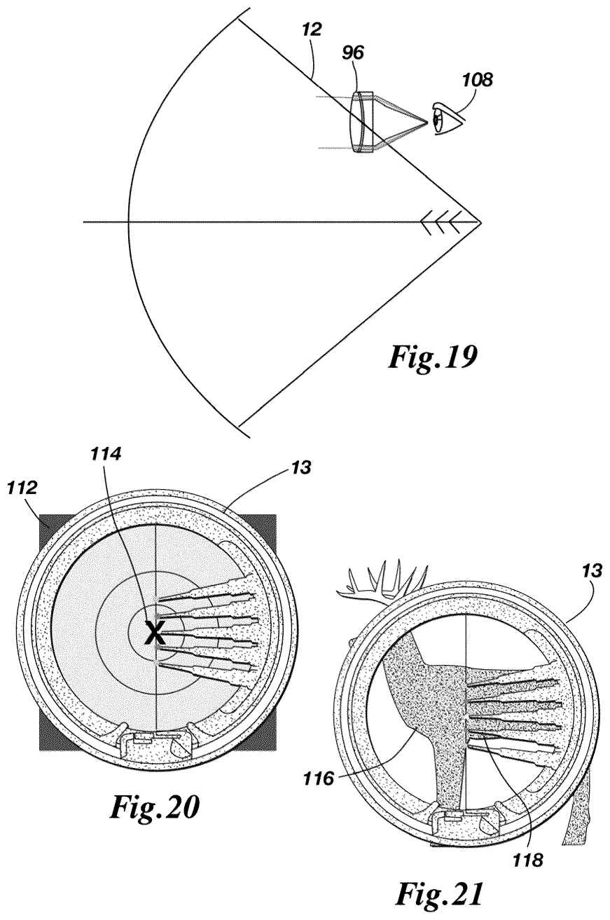

Referring to comparisons of FIG. 18, the white light 92 traveling through a positive single verifier glass 90 lens is refracted to red R and blue B at the image plane 93 or retinal plane 94. The white light traveling through a verifier achromatic lens 96 has its aberrations of red R and blue B corrected to white at the image plane 106 or retinal plane 108. This correction of aberrations is shown in the archery context as white light impacts the retinal image plane 108. In FIG. 19, this is again shown as a clear, clean, crisp unrefracted image plane. In FIG. 20 as to what the archer sees through his peep sight 36, 44 with a clarifier lens 96 and forward sight 13 is a clear, clean, crisp unrefracted image 114 of the target 112. This aberration correction is also shown in FIG. 21 as to what the archer sees through his peep sight 36, 44 with a clarifier lens 96 and forward sight 13 that is a clear, clean, crisp unrefracted image of the deer 116.

The above illustrations are not intended to limit the scope of the present invention. Rather, the true scope of the present invention is defined by the following claims.

What is claimed:

1. An achromatic lens for a peep sight is to be mounted onto an archery bowstring, the achromatic lens comprising a positive verifier or a negative clarifier glass lens joined to a negative or a positive flint lens, respectively, wherein the achromatic lens is to be situated and retained in a lens cavity of the peep sight, the peep sight has a peep sight body mounted to the bowstring with an internal hole therethrough with a front end to be facing a front bow sight and a rear end to be facing an archer's eye, an aperture with the lens cavity has a front end, a rear end and is adapted for locking engagement with the hole of the body, the aperture has a passage therethrough axially aligned with the peep sight body hole with a front end facing the front bow sight and a rear end to be facing the archer's eye, and the lens cavity is in the passage suitably adjacent to the aperture's front end.

2. The achromatic lens of claim 1, wherein the positive verifier or the negative clarifier glass lens is joined in flush contact with cement to the negative or the positive flint lens.

3. The achromatic lens of claim 1, wherein the peep sight has a viewing hole adjacent to the aperture's front end.

4. The achromatic lens of claim 1, wherein the peep sight has a viewing hole which may vary in diameter.

5. The achromatic lens of claim 1, wherein the positive clarifier glass lens and the negative flint lens are convex and concave respectively.

6. An achromatic lens for a peep sight is to be mounted onto an archery bowstring, the achromatic lens comprising a positive verifier or a negative clarifier glass lens joined in flush arrangement by cement to a negative or a positive flint lens, respectively, wherein the achromatic lens is to be situated and retained in a lens cavity of the peep sight, the peep sight has a peep sight body mounted to the bowstring with an internal hole therethrough with a front end to be facing a front bow sight and a rear end to be facing an archer's eye, an aperture with the lens cavity has a front end, a rear end and is adapted for locking engagement within the hole of the body, the aperture has a passage therethrough axially aligned with the body hole with a front end facing the front bow sight and a rear end to be facing the archer's eye, and the lens cavity is in the passage suitably adjacent to the aperture's front end.

7. The achromatic lens of claim 6, wherein the peep sight has a viewing hole which may vary in diameter.

8. An achromatic lens for an archery peep sight is to be mounted onto an archery bowstring, the achromatic lens comprising a positive verifier or a negative clarifier glass lens joined in flush engagement by cement to a negative or a positive flint lens, respectively.

9. The achromatic lens of claim 8, wherein the achromatic lens is to be situated and retained in a lens cavity of the peep sight, the peep sight has a peep sight body mounted to the bowstring with an internal hole therethrough with a front end to be facing a front bow sight and a rear end to be facing an archer's eye, an aperture with the lens cavity has a front end, a rear end and is adapted for locking engagement within the hole of the body, the aperture has a passage therethrough axially aligned with the body hole with a front end facing the front bow sight and a rear end to be facing the archer's eye, and the lens cavity is in the passage suitably adjacent to the aperture's front end.
